(19) United States
(12) Patent Application Publication
(10) Pub. No.: US 2013/0174381 A1
(43) Pub. Date: Jul. 11, 2013

(54) Sports Headset Mouth Privacy Clip

(71) Applicant: Khalil Zane McClellan, Columbia, SC (US)

(72) Inventor: Khalil Zane McClellan, Columbia, SC (US)

(73) Assignee: Khalil Zane McClellan, Columbia, SC (US)

(21) Appl. No.: 13/282,895

(22) Filed: Jan. 7, 2012

(51) Int. Cl. H04R 1/08

(52) U.S. Cl. CPC H04R 1/086
USPC 24/3.12

(57) ABSTRACT

Sports Headset Mouth Privacy Clip is a rectangular shaped piece made of abs plastic for durability, with acoustic foam on the inside to allow voice sound clarity during communication. Also has a “C Shaped” clip to attach mouthpiece. Measuring 4.25 horizontally/2.25 vertically it allows verbal privacy while using Communication Headsets. The clip is to be attached to Mobile Headset popularly used in American Football both college and professional. This clip allows for each individual to communicate with team in privacy without opposing team reading there lips and figuring out what they are trying to communicate within the team.

### BACKGROUND

I have done a thorough, in depth search of this product to inquire if this invention has already been produced, which it has not. The only product I found was a product produced in Australia, however this invention I am currently referring to is a full electronic headset. Which a mouthpiece hangs from the headset itself, the mouthpiece contains the speaker which you must manually place to your mouth each time you wish to speak. Much like the old rotary telephones which you had to hold one part to your ear and other to your mouth. This in no way compares to my invention described above and I have found no other products/inventions that compare to my invention. I declare this is the first invention such as this to be created.

### SUMMARY OF INVENTION

The Sports Headset Mouth Privacy Clip is made to protect communication while using a communication headset, giving each individual verbal privacy. The clip is made of abs plastic with acoustic foam attached on the inside for sound clarity. Also, has a c shape clamp attached in order to the clip to attached directly to headset.

### DETAILED DESCRIPTION

In the sports industry such as football, college football, soccer, etc. Headsets are used for staff and coaches to communicate with each other during the duration of games and/or practice. These headsets are manufactured by Motorola for the National Football League (NFL) and AT&T manufactures the headsets used in NCAA Football League. This product is not specially for the sports previously mentioned, however are for the headsets which are used within these sports. I noticed quite a few coaches cover there mouths when corresponding with other coaches, staff or players to keep the opposing team from reading their lips and figuring out what the coaches are saying to figure what there next move/play may or may not be. They usually use the play card or book to cover there mouths due to mouth piece of the headset not being large enough to cover and allow verbal privacy. This invention which I have titled as “Sports Headset Mouth Privacy Clip” gives privacy to the individual using this invention. This product is made of a thin, black ABS plastic which is flexible, it contains a “C” shaped clip to mount the privacy clip onto the actual headset. It also contains acoustic foam on the inside of the mouthpiece to increase sound clarity and quality such as the foam used within music studios. This clip is easily mounted to the headset and removable at anytime. This invention was thought of in accordance to the sport of U.S. Football, however is not to be confined to the sport of football. This is a product to block the mouth when using a headset rather it be in sports, corporate industries or common usage. The drawings which I have attached to this application will specify the design and usage of this product. I

### DESCRIPTION OF DRAWINGS

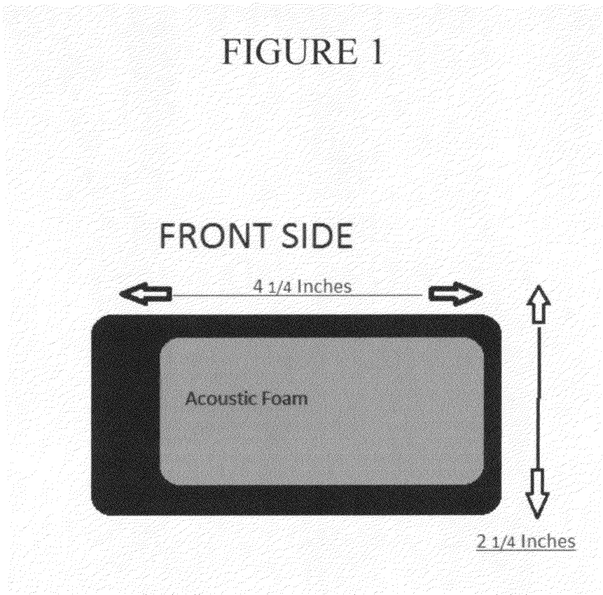

Drawing Description FIG. 1: The drawing shows the front side of the headset clip the measurements are 4.25 Inches horizontally and 2.25 Inches vertically. The grey area is made with acoustic foam, it is attached to an abs plastic.

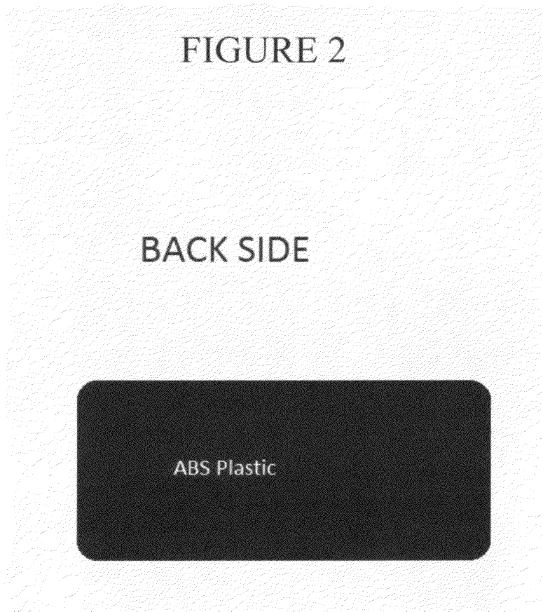

Drawing Description FIG. 2: The drawing shows the backside of the headset clip made of abs plastic. Measurements consists of 4.25 Inches horizontally and 2.25 Inches vertically.

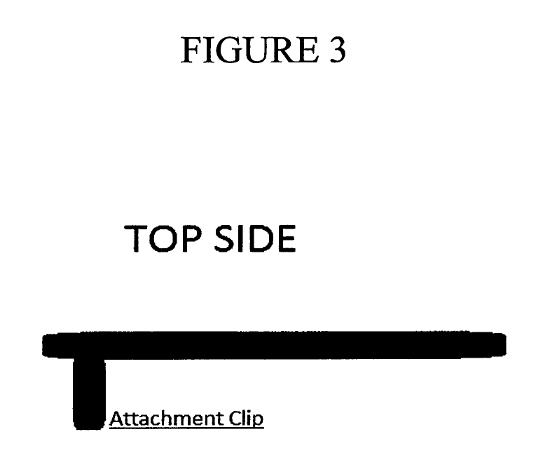

Drawing Description FIG. 3: The drawing shows the top side of the headset clip made with abs plastic. Measurements are 4.25 horizontally and 2.25 vertically, in the view the attachment clip is also visible which is also made of abs plastic. Made in a “C Shape” to attach to actual headset.

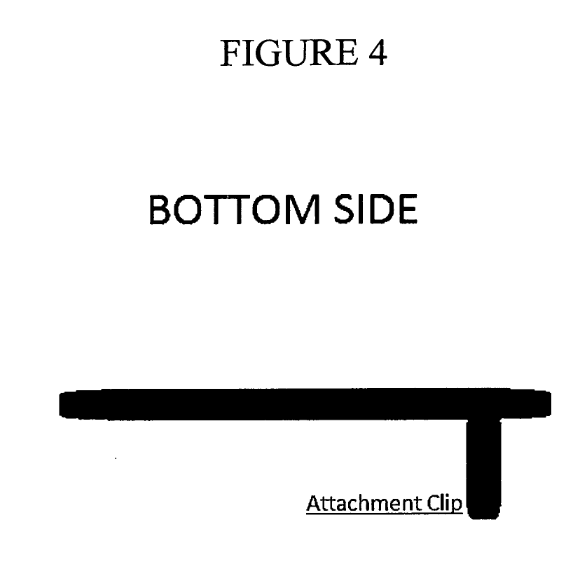

Drawing Description FIG. 4: The drawing shows the bottom side of the headset clip. Measurements 4.25 horizontally and 2.25 vertically, made with abs plastic. Attachment clip is also visible in the view made of a “C Shape” made to attach to actual headset.

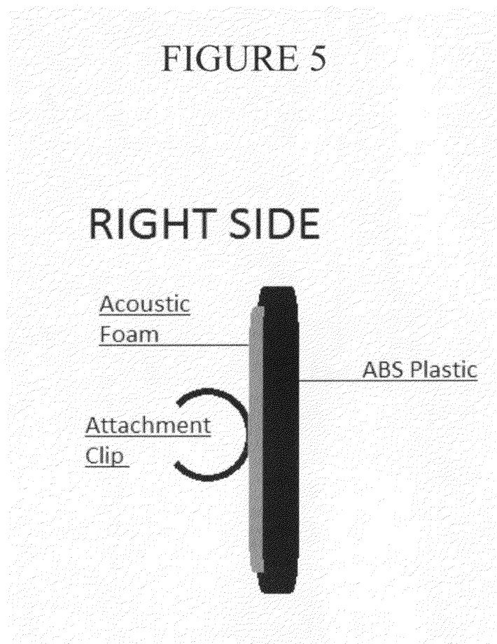

Drawing Description FIG. 5: The drawing show the right side of the headset clip starting from left to right you see the “C shape clip made to attach directly to actual headset. Grey area is the acoustic foam made for sound clarity. The black piece is made of abs plastic measuring 4.25 horizontally and 2.25 vertically.

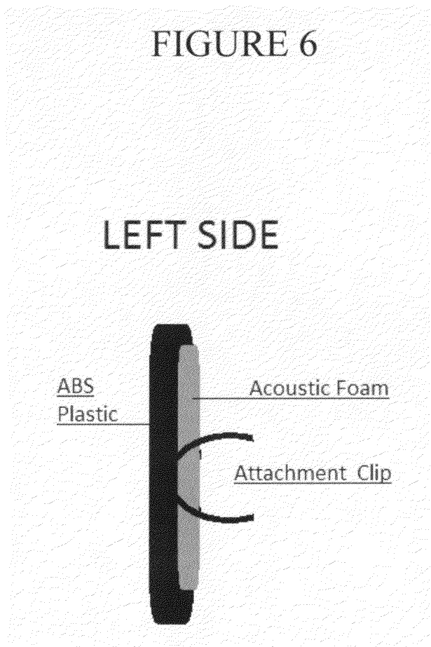

Drawing Description FIG. 6: The drawing shows the left side of the headset clip. From left to right is the black abs plastic measuring 4.25 horizontally and 2.25 vertically. Grey area is made of acoustic foam made for sound clarity. Attachment clip made of a “C Shape” is made to attach directly to actual headset.

### EXAMPLES OF USE

1. During National Football League football games, coaches, assistant coaches and staff can use the clip to protect the communications from the opposing team.
2. NCAA Football college coaches and staff can use this clip to attached to their headset commonly made by AT&T to protect the verbal communication during the games in order to refuse opposing coaches vision of the speech.

1. A Sports Headset Mouth Privacy Clip comprising: a clip made of abs plastic and acoustic foam. Made to protect communication during usage of headset, it measures 4.25 horizontally and 2.25 vertically. These headsets are majority used in American Football (NFL Football and College) the clip gives coaches and staff privacy to refuse opposing team vision of communication.
